(19) United States
(12) Patent Application Publication
(10) Pub. No.: US 2013/0029867 A1
(43) Pub. Date: Jan. 31, 2013

(54) CONCENTRATION MEASUREMENT METHOD AND CONCENTRATION MEASUREMENT SYSTEM

(71) Applicants: Takao TANAAMI, Musashino-shi (JP); Hidetoshi AOKI, Musashino-shi (JP); Souichirou SHIMODA, Musashino-shi (JP)

(72) Inventors: Takao TANAAMI, Musashino-shi (JP); Hidetoshi AOKI, Musashino-shi (JP); Souichirou SHIMODA, Musashino-shi (JP)

(73) Assignee: YOKOGAWA ELECTRIC CORPORATION, Tokyo (JP)

(21) Appl. No.: 13/556,912

(22) Filed: Jul. 24, 2012

(30) Foreign Application Priority Data
Jul. 25, 2011 (JP) 2011-162518

(51) Int. Cl. C40B 30/04; C40B 40/10

(52) U.S. Cl. 506/9; 506/18

(57) ABSTRACT

A concentration measurement method for measuring the concentration of a target molecule, capable of carrying out a quantitative measurement of the concentration by use of a chip. A relationship between concentration of a target molecule of a calibration liquid, found with respect to a calibration chip identical in performance to the measurement chip and a measured quantity of light is found when the probe molecule and the target molecule undergo bonding reaction in a condition where the specific probe molecule and the target molecule undergo bonding reaction using the calibration chip. The concentration of a target molecule in the measured target liquid is worked out on the basis of the measured quantity of light, found in the step of finding the measured quantity of light by use of a relationship found with respect to a calibration chip

This application claims priority from Japanese Patent Application No. 2011-162518, filed on Jul. 25, 2011, the entire contents of which are herein incorporated by reference.

### BACKGROUND

1. Field of the Invention

The present invention relates to a concentration measurement method for measuring concentration of a target molecule in a solution by use of a measurement chip provided with a probe molecule fixed on a substrate, and so forth.

2. Related Art

A method for detecting a target DNA by use of a DNA chip where respective sites of probe molecules fixed on a substrate are in array has been in widespread use. Labeling of the target DNA bonded to a probe molecule through hybridization by use of a fluorescent material enable the target DNA to be detected by an optical reader.

With the DNA chip described as above, if probe molecules differing from each other on a site-by-site basis are allocated to respective sites, this will enable a large variety of target DNAs to be simultaneously detected by one measurement. A quantity of fluorescence at each site varies according to an amount of each target DNA that is bonded thereto by means of hybridization.

### RELATED ART LITERATURE

### Patent Literature

Patent Document: JP 2007-212478A

### SUMMARY OF THE INVENTION

With the use of the DNA chip, a multitude of genes can be simultaneously detected. However, a quantity of fluorescence, measured by the reader shows only a relative amount of the target DNA bonded to a probe DNA, and it is not possible to find an absolute value of concentration of the target DNA contained in a solution. Accordingly, measurement is used only for screening whereby relative distribution of a multitude of genes is found, and with the current state of the art, the DNA chip is not used for measurement of an absolute concentration of the target DNA contained in the solution, for example, the number of molecules [M/L] per unit volume, and so forth.

That is, in the case of measurement by use of the DNA chip, luminance of each site is grasped by use of an image to thereby relatively check only a state of expression, and quantitative digitization of concentration of each site, on the basis of output signal characteristics of a camera, saturation characteristics of a probe DNA, and so forth, is not in itself a common practice, much less control of chip manufacturing, and a measurement method such that a numeric value thereof has an absolute significance (for example, the concentration of the target DNA in the solution).

In contrast, expression of a specific gene, and variation thereof, and so forth can be measured by use of real-time PCR (polymerase chain reaction). However, it is not possible to simultaneously measure a multitude of genes because of a problem such as interference between primers, at the time of amplification, and so forth, so that it is in effect difficult to apply the real-time PCR to a multitude of genes. Furthermore, an operation for preparing a calibration curve in order to compensate for a difference in enzyme activity is required every time a measurement is made, which causes a large load on a worker.

It is an object of the invention to provide a concentration measurement method for measuring the concentration of a target molecule, capable of carrying out a quantitative measurement of the concentration by use of a chip.

In accordance with a first aspect of the invention, there is provided a concentration measurement method for measuring the concentration of a target molecule by use of a measurement chip provided with a substrate and a probe molecule fixed on the substrate, said method comprising the steps of executing hybridization in a specific hybridization condition, by use of a calibration chip identical in performance to the measurement chip, thereby finding a relationship between concentration of a target molecule in a specific range of a calibration liquid with respect to the calibration chip and a measured light quantity (light power), finding the measured light quantity at a time when hybridization using the measurement chip is applied to a measurement target solution under the specific hybridization condition, and working out concentration of a target molecule in a specific range of the measurement target solution, said specific range being identical to the specific range of the calibration liquid, on the basis of the measured light quantity, found in the step of finding the measured light quantity by use of the relationship found with respect to the calibration chip.

With the concentration measurement method, the concentration of a target molecule in the measurement target solution is worked out on the basis of the measured light quantity, found in the step of finding the measured quantity of light by use of the relationship found with respect to the calibration chip, so that a quantitative measurement of the concentration can be made.

In accordance with a second aspect of the invention, there is provided a concentration measurement chip comprising a substrate, and a probe molecule fixed on the substrate, said concentration measurement chip being capable of measuring concentration of a target molecule bonded to the probe molecule through hybridization, wherein a relationship between concentration of a target molecule in a specific range of a calibration liquid in a specific hybridization condition with respect to a calibration chip identical in performance to the measurement chip, and a measured quantity of light is obtained as calibration information on the concentration measurement chip.

In accordance with a third aspect of the invention, there is provided a concentration measurement chip comprising a substrate, and a probe molecule fixed on the substrate, said concentration measurement chip being capable of measuring concentration of a target molecule bonded to the probe molecule, wherein a relationship between concentration of the target molecule in a specific range of a calibration liquid in a specific bonding condition with respect to a calibration chip identical in performance to the measurement chip, and a measured quantity of light is obtained as calibration information on concentration of the target molecule in a specific range identical to the specific range of the calibration liquid and the quantity of light.

With the concentration measurement method, the concentration of a target molecule in the measurement target solution is worked out on the basis of the measured quantity of light, found in the step of finding the measured quantity of light by use of the relationship found with respect to the calibration chip, so that a quantitative measurement of the concentration can be made.

A bond between the probe molecule and the target molecule may include hybridization between nucleic acids or antigen-antibody bonding reaction between protein and antibody, or bonding reaction between molecules of proteins.

### BRIEF DESCRIPTION OF THE DRAWINGS

FIGS. 1(A) and 1(B) each show a DNA chip, in which FIG. 1(A) is a plan view showing a configuration of the DNA chip, and FIG. 1(B) is view showing a group of DNA chips manufactured so as to be identical in performance to each other;

FIG. 2 is a flow chart showing an operation procedure at a time when the DNA chip is used;

FIGS. 3(A) to 3(C) each are a view for describing principles behind a calibration method for obtaining the absolute-value light quantity system, in which FIG. 3(A) is view showing a state at the time of calibration FIG. 3(B) is view showing a state at the time of measurement, and FIG. 3(C) is view showing a relationship between light quantity per unit area of the light-receiving element and gradation of an luminance signal output of the camera;

FIG. 4 is a plan view showing a configuration of a chemical reaction cartridge with a chip housed therein;

FIG. 5 is a sectional view taken on line V-V of FIG. 4; and

FIGS. 6(A) and 6(B) each are a view showing the construction of the target molecule detection chip 10A, in which, FIG. 6(A) is a perspective view, and FIG. 6(B) is a sectional view taken on line B-B of FIG. 6(A);

FIG. 7 is a view showing an operation at the time of the solution transfer;

FIG. 8 is a view showing a biochip manufacturing system;

FIG. 9 is a graph showing a relationship between the concentration of a target DNA and a quantity of light of a DNA chip after hybridization applied thereto;

FIG. 10 is a view showing a flow of measurement;

FIG. 11 is a view showing a flow of measurement;

FIG. 12 is a view showing an example of the reading system; and

FIG. 13 is graphs showing results of a test on reproducibility of the hybridization.

### DETAILED DESCRIPTION OF EXEMPLARY EMBODIMENTS

There is described hereinafter one embodiment of a concentration measurement method according to the invention.

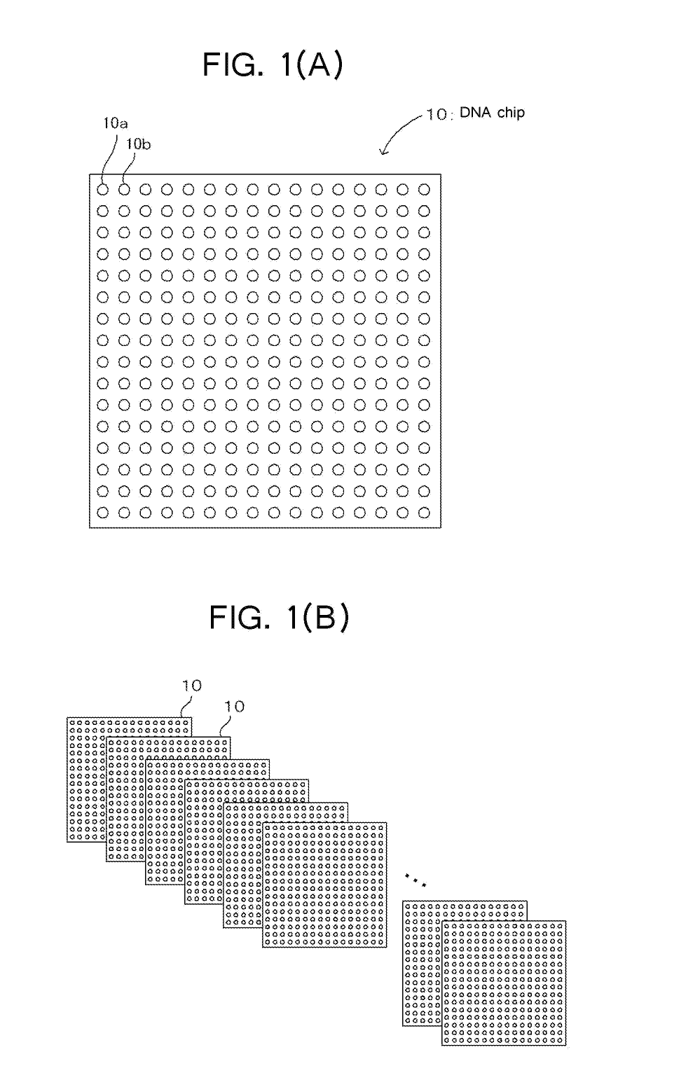

FIG. 1(A) is a plan view showing a configuration of a DNA chip, and FIG. 1(B) is view showing a group of DNA chips manufactured so as to be identical in performance to each other.

As shown in FIG. 1(A), sites 10a, 10b, . . . are provided on the surface of a DNA chip 10, a probe DNA in array complementary to that of a target DNA being disposed at each of the sites. Any suitable number of the sites, for example, in a range of around 2 to 30,000 sites, can be selected according to usage of the chip. Allocation of probes differing from each other on a site-by-site basis to each site enables plural types of target DNAs to be simultaneously measured. With the present embodiment, plural pieces of the DNA chips 10, 10 . . . , identical in performance to each other (FIG. 1(B)), using a part of the DNA chips, as a calibration chip, while using the balance as measurement chips.

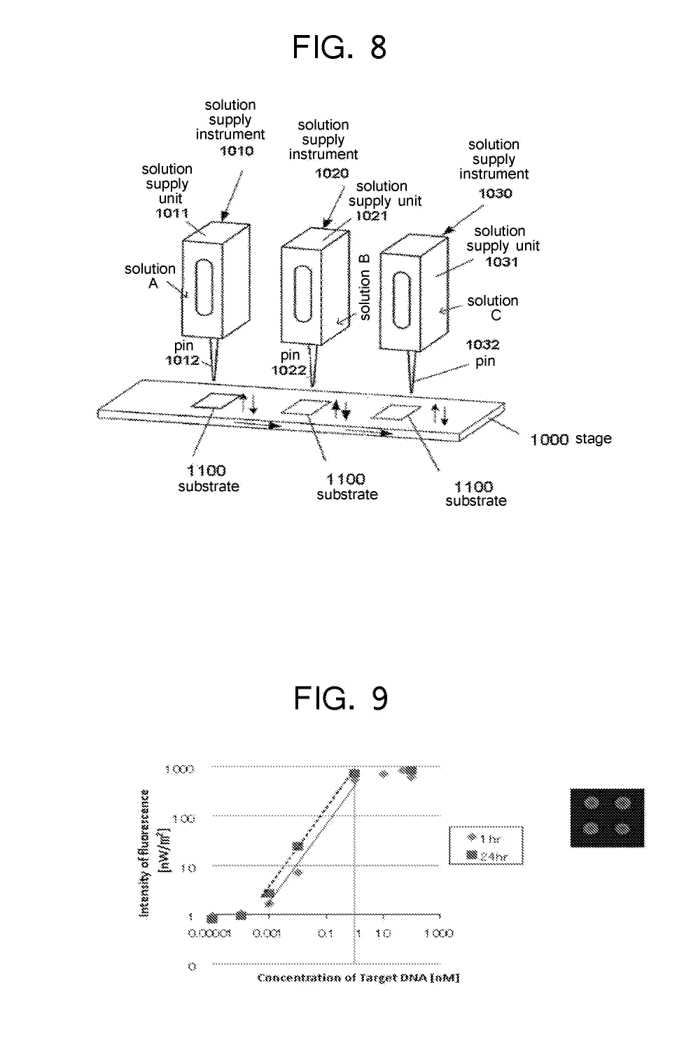

With the DNA chip described as above, a site (spot) can be formed by bringing a solution of a probe DNA into contact with the surface of a substrate via pins, as shown in Japanese Patent Application No. 2006-78356 (a biochip manufacturing system). FIG. 8 shows the biochip manufacturing system described as above. With this method, not only DNA but also RNA, a protein chip, and so forth can be formed. Further, formation of the respective sites not only by use of pin contact but also by use of inkjet printing, photolithography, and so forth is commonly adopted. A predetermined amount of a probe DNA corresponding to a specific gene is fixed on each site.

Now, there is shown hereinafter an important finding leading to the present invention. FIG. 9 shows a relationship between the concentration of a target DNA and a quantity of light of a DNA chip after hybridization applied thereto. In this experiment, use was made of an oligomer DNA, and the hybridization was applied under conditions of 1 hr, and 2 hr, respectively.

The horizontal axis indicates concentration [nM] of a target DNA, and the vertical axis indicates an absolute light quantity value [nW/m²] as described later. As is evident from FIG. 9, the quantity of light is found not higher than 1 [nW/m²] before the concentration of the target DNA reaches 0.001 [nM], however, once the concentration exceeds said value, the concentration and the quantity of light linearly rise in proportion to each other. Further, if the concentration further rises, the quantity of light is saturated to reach a given value. More specifically, if a range of the concentration in a solution is limited to a specified range, a proportional relationship between the concentration in the solution, and a light quantity value can be obtained. If the specified range is calibrated, and a coefficient thereof is found, this will enable the concentration to be reversely worked out from the light quantity value. The coefficient is hereinafter referred to as a probe coefficient. As is evident from the figure, more luminous light quantity can be obtained by prolonging hybridization time in a specific comparison range even if the concentration of the target DNA is unchanged. More specifically, even in the case of chips identical to each other, if a hybridization condition is changed, it is necessary to change the probe coefficient.

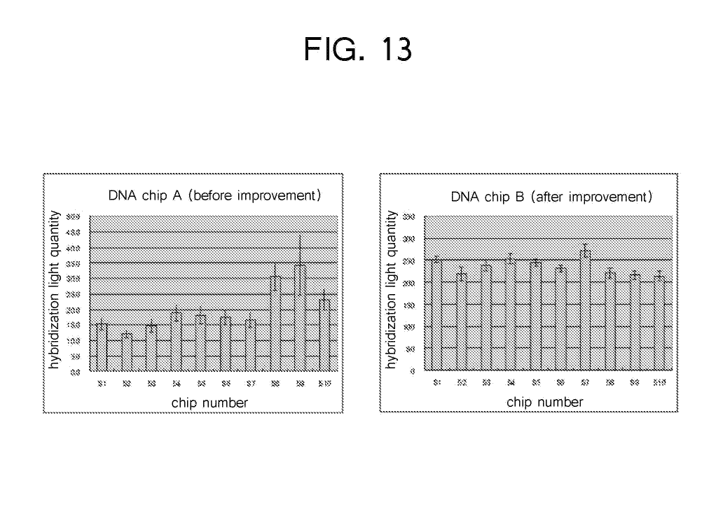

Further, in FIG. 13, there are shown results of a test on reproducibility of the hybridization. FIG. 13 shows an example of a conventional DNA chip (DNA chip A). Even in the case where respective concentrations of the DNA chips are identical to each other, variation in light quantity after hybridization is large. Quality control thereof was conducted by use of an absolute light quantity system as described later, and improvement in a process was carried out. As a result, it tuned out that a stable light quantity was obtained against the respective concentrations of the DNA chips, identical to each other, as shown in FIG. 13 (DNA chip B). Two findings described as above constitute an important basis of the present plan.

Next, there is described hereinafter a specific application method for the DNA chip 10.

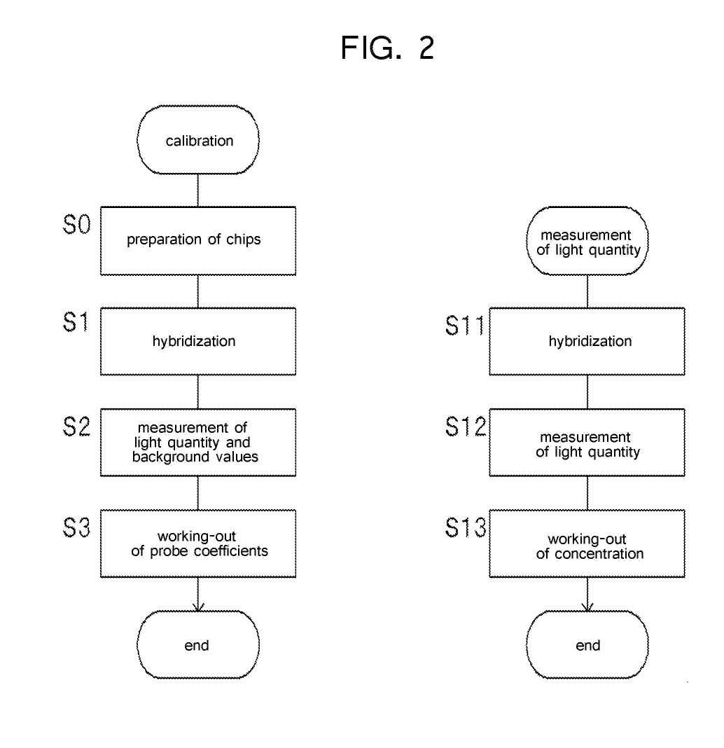

FIG. 2 is a flow chart showing an operation procedure at a time when the DNA chip 10 is used. Steps S0 to S3 indicate a procedure for calibrating a chip.

First, the DNA chips 10, 10 . . . , identical, in effect, in respect of performance to each other (FIG. 2(B)) are prepared (the step S0). With the present embodiment, “identical, in effect, in respect of performance” in the present specification means that the DNA chips are, in effect, identical in respect of performance to each other to such an extent as to enable a measurement result at the time of calibration described later to be effectively utilized at the time of measurement.

Subsequently, a solution of a dummy target DNA for calibration is prepared against one sheet of calibration chip selected from the DNA chips 10, 10 . . . , on an individual probe DNA basis. Hybridization is executed by use of a calibration liquid prepared by mixing respective solutions of dummy target molecules T₁ to T_{N} in prescribed concentrations A₁ to A_{N}, respectively (the step S1). Numerical subscripts ₁ to _{N} are numbers corresponding to respective varieties of the dummy target DNAs. The hybridization is executed under the standard condition where various conditions such as temperature, a labeling method (pre-staining/post-staining), and so forth are specified. The pre-staining refers to a method for labeling a target DNA before hybridization, while the post-staining refers to a method for labeling a target DNA after hybridization.

Subsequently, a measurement is made on the quantity of light of the DNA chip 10 (the calibration chip), thereby measuring quantities of light, B₁ to B_{N} [W/m²] of the respective sites corresponding to the respective target DNAs. Further, background values (C₁ to C_{N}) [W/m²] attributable to excitation light are measured (the step S2).

Then, probe coefficients kp₁ to kp_{N} are worked out (the step S3). Kpᵢ (I=1 to N) is defined by the following formula:

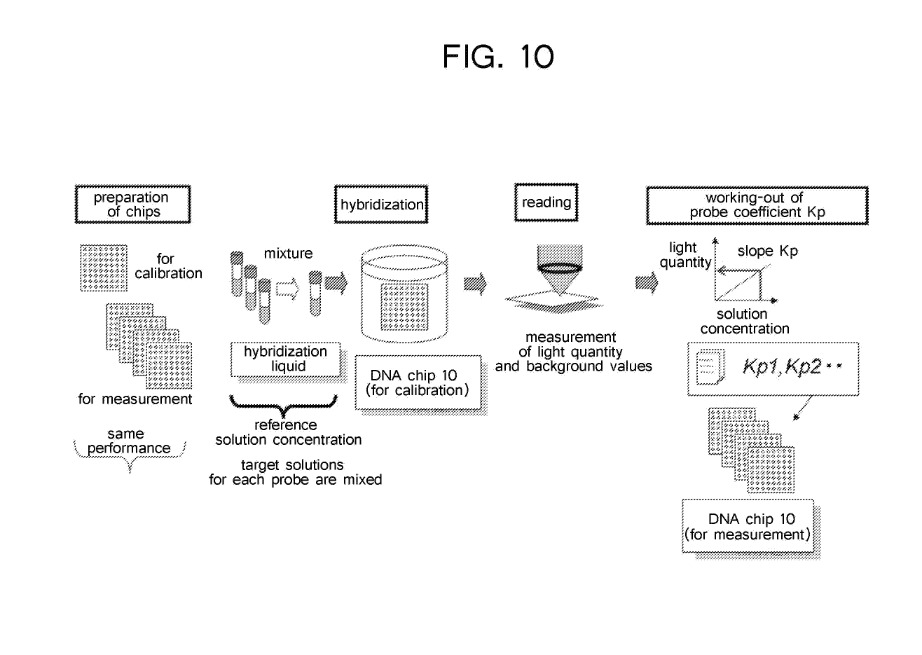

Kpᵢ=(Bᵢ to Bᵢ)/Aᵢ [W/m²]/M or [W/m²]/molecule], and so forth (providing i=1 to N). The probe coefficients kp₁ to kp_{N} are defined as respective values corresponding to a ratio of the concentrations of the respective target DNAs to quantities of light from the respective sites corresponding thereto, being at various values according to the varieties of the target DNAs. In FIG. 10, there is shown the flow described in the foregoing.

In FIG. 2, steps S11 to S13 show a procedure for measurement using the DNA chip 10 (a measurement chip) for measurement,

First, hybridization using the measurement chip is applied to a measurement target solution under the condition of the hybridization described as above (the standard condition) (the step S11).

Subsequently, the quantity of light of the DNA chip 10 (the measurement chip) is measured, thereby measuring respective quantities of light, y₁ to y_{N} [W/m²] of the sites corresponding to the respective target DNAs (the step S12). In this case, measurement in an absolute-value light quantity system is required, and a measurement method for the absolute-value light quantity system is described later.

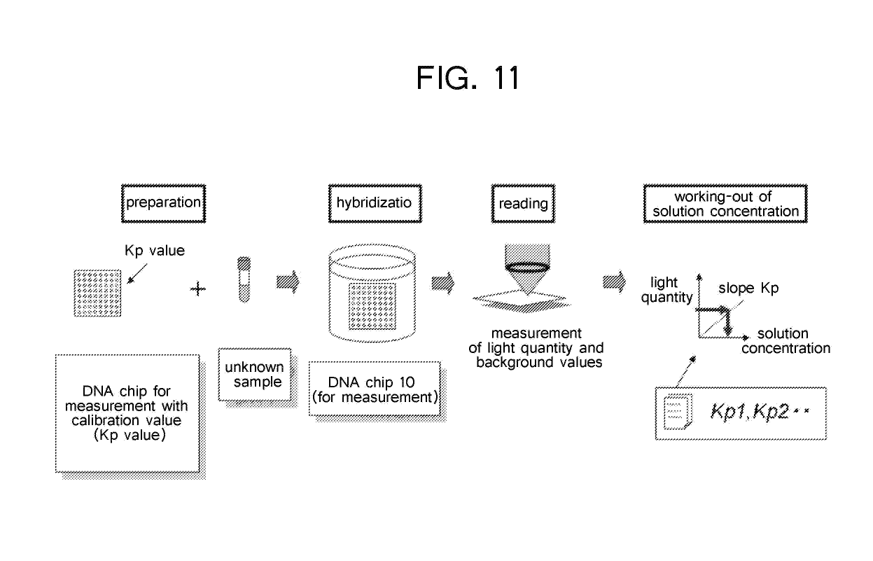

Subsequently, the concentrations A₁ to A_{N} of the respective target DNAs are worked out from the quantities of light, y₁ to y_{N}, respectively (the step S13). In this case, the concentrations A₁ to A_{N} of the respective target DNAs in the measurement target solution are reversely worked out by use of the probe coefficients kp₁ to kp_{N}, respectively. The concentration Aᵢ (ᵢ=1 to N) is worked out by a formula Aᵢ=(yᵢ−Zᵢ)/kpᵢ (providing ᵢ=1 to N). Zᵢ denotes the background value. In FIG. 11, there is shown the flow described in the foregoing.

Thus, with the present embodiment, a quantity of light is converted into concentration by use of the probe coefficients kp₁ to kp_{N} worked out by use of one sheet of the DNA chip 10 as the calibration chip, thereby enabling respective concentrations of a multitude of the target DNAs in the measurement target solution to be quantitatively found by one measurement. An operation for preparing a calibration curve for every measurement is not required either.

Next, a method for obtaining the absolute-value light quantity system is described hereinafter. The absolute-value light quantity system is a system for ensuring such a precision as to enable a read value on a quantity of light of an image to be found at the same value every measurement time by stabilizing a light source, an optical system, and so forth, and rendering a calibration method of a reader thereof to be nationally traceable, thereby enabling the read value to be acceptable as a physically absolute value notation ([W/m²] and so forth) based on the SI unit system.

In the case where concentration is reversely worked out from a quantity of light, it is required that use be unfailingly made of an optical system equivalent in characteristics to an optical system with which a first calibration has been performed. In the case of a common bio.chemical system measuring instrument, there is given no guarantee as to accuracy on a read value of a quantity of light. That is, since respective read values of the quantities of light from plural units of the measuring instruments differ from each other, there is no guarantee that a calibrated optical system is identical to a measurement optical system identical to the calibrated optical system. Accordingly, it is required that measurement be concurrently conducted by use of a calibrated instrument itself at all times. However, even in the case of using the plural units of the measuring instruments, use of the absolute-value light quantity system will enable mutual guarantee as to accuracy on the read value, and further, guarantee as to a change over time as well is provided, so that eve if a instrument used for calibration by a chip maker is different from a instrument used for measurement by an end-user, this will cause no problem with the passage of time.

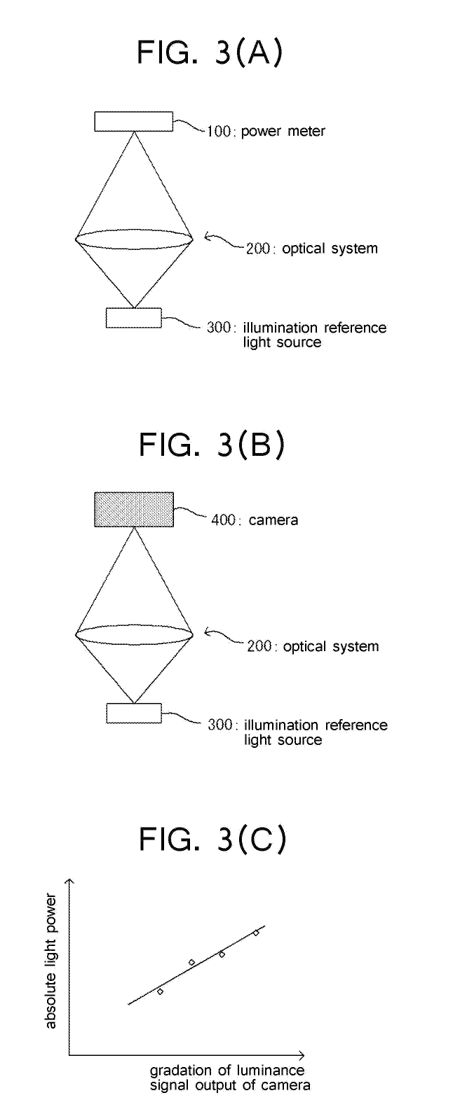

FIGS. 3(A) to 3(C) each are a view for describing principles behind a calibration method for obtaining the absolute-value light quantity system. In FIG. 3(A), reference numeral 100 denotes a power meter, 200 an optical microscope, and 300 an illumination reference light source such as an LED, and so forth.

The power meter 100 has traceability to a national standard of optical power, having interchangeability with the national standard. A quantity of light from the illumination reference light source 300 is measured by the power meter 100 via the microscope 200, and the quantity of the light from the illumination reference light source 300 is calibrated on the basis of the power meter 100,

Next, as shown in FIG. 3(B), the total light quantity of the illumination reference light source 300 as calibrated is detected by a light-receiving element (not shown) of a light quantity detector (for example, a camera) 400 via the microscope 200. In this case, by comparing an output value [W] of the power meter 100 with a total value of output values for all the pixels of the light quantity detector 400, it is possible to calibrate a relationship between a quantity of light received from the light-receiving element of the camera 400 and a camera output signal, that is, a value of [(W/m²)/gradation].

In FIG. 3(C), there is shown an example of the result of calibration by the calibration method described as above. FIG. 3(C) is view showing a relationship between an absolute light quantity per unit area of the light-receiving element and gradation of an luminance signal output of the camera. In the case where the light source 300 emits, for example, green light, a relationship expressed by Y=2.61E−06X+2.57E−05 will hold, and in the case where the light source 300 emits red light, a relationship expressed by Y=1.81E−06X−5.26−05 will hold. In the respective expressions, X denotes gradation, and Y denotes light quantity.

If the camera that is calibrated as above is used for a photo detector of a reading system (for example, a reading system described in JP 2001-311690A, proposed by the present applicant, and so forth), this will enable a light quantity of fluorescence to be measured directly from a gradation value of an image as measured.

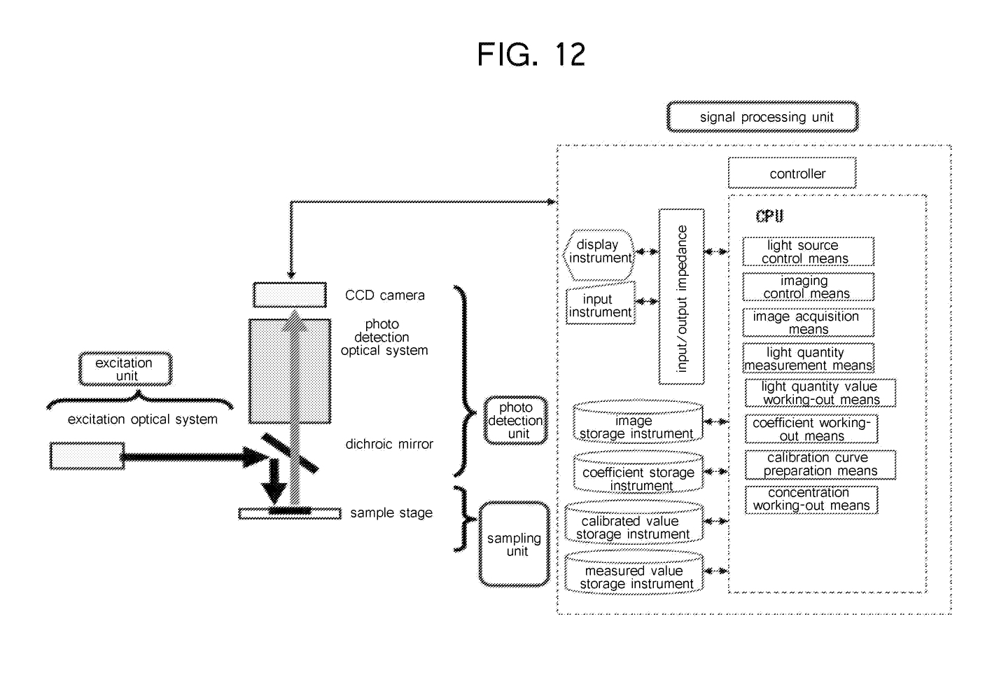

FIG. 12 shows an example of the reading system described as above. The reading system is comprised of an excitation unit, a sampling unit, a photo detection unit, and a signal processing unit. Fluorescence generated by irradiation of a sample with laser light from the excitation unit is received by a CCD camera via the photo detection unit, and a signal of the fluorescence is processed by the signal processing unit. At the time of calibration, storage of a calibration value, together with control of the reading system, is performed. In the case of using the reading system as a measuring instrument, the concentration of the target DNA is worked out from the probe coefficient of a chip, as pre-inputted, and a measured light quantity.

On the other hand, a quantity of light occurring from fluorochrome can be found by processing as follows. Power ΔI of light absorbed by fluorochrome is given by the following expression:

ΔI=2.3×10³×α×Io×n/(Na×S) [W] (1)

where
α: molar absorption coefficient 8×10⁴ [M⁻¹ m⁻¹]
Io: incident light quantity [W]
n: the number of molecules (pieces)
Na: Avogadro number 6×10²³
S: area

The quantity of fluorescence occurring from fluorochrome can be estimated by taking a quantum effect, and so forth into consideration.

Accordingly, by causing a quantity of fluorescence, measured by use of the camera that is calibrated by the calibration method described as above to correspond with an estimated value of the quantity of the fluorescence, it is possible to directly estimate the number “n” of fluorescent molecules on a chip.

Thus, with the concentration measurement method according to the invention, measurements are conducted in the absolute-value light quantity system in both the steps. That is, at the time of calibration (the step S2 in FIG. 2), and at the time of measurement (the step S12 in FIG. 2), whereupon the probe coefficients kp₁ to kp_{N} can be worked out, and concentrations can be reversely worked out by use of the probe coefficients kp₁ to kp_{N}, respectively.

With the embodiment described in the foregoing, the probe coefficients kp₁ to kp_{N} are worked out with respect to all the target DNAs by use of one chip, however, a solution for calibration may be prepared on an individual target DNA basis to thereby carry out hybridization. In this case, there is the need for using one calibration chip with respect to the individual target DNA.

In hybridization, there exists mutual interference (cross-contamination) among plural target DNAs. Accordingly, if the respective concentrations A₁ to A_{N} of the dummy target molecules T₁ to T_{N} at the time of calibration are approximated to the respective concentrations at the time of measurement, this will compensate for the effect of the mutual interference, so that measurement accuracy can be enhanced.

With the present invention, the calibration of a chip is performed on the part of, for example, a chip manufacturer, and gene measurement using the chip can be performed on the part of a purchaser of the chip. In this case, results of the calibration (calibration information), that is, a relationship (the probe coefficient according to the present embodiment) between the concentration of a target molecule in a calibration liquid and a measured quantity of light is given to the purchaser of the chip, so that quantitative measurement on the part of the purchaser of the chip can be conducted.

Further, in the case of manufacturing a custom-made chip for a prescribed target molecule, the custom-made chip can be calibrated to add calibration information thereto before putting to the market.

With the present invention, if the hybridization condition at the time of calibration is brought into agreement with the hybridization condition at the time of measurement as much as possible, this will enable highly accurate measurement of concentration. For this reason, it is highly desirable to explicitly indicate the hybridization condition at the time of calibration in detail so as to enable agreement to be achieved in respect of temperature of the hybridization, the labeling method for a target molecule, a base concentration, hybridization time, and other conditions.

Further, if reading systems identical in type to each other are each used at the time of calibration, and at the time of measurement, respectively, this will enable an error attributable to a difference between the reading systems to be inhibited. Adoption of the absolute-value light quantity system, in particular, renders it possible to use a light quantity value for general purpose, based on the international standard, regardless of a manufacturer, an instrument model, an instrumental error, and a change over time.

With the present invention, a through-type chip incorporating a through hole with a probe molecule fixed therein can be used as the calibration chip, and the measurement chip, respectively. For the through-type chip, use can be made of a variety of types of chips. For example, a chip provided with a probe solidified in a porous filter, fiber-type chip {for example, “Genoperl®” a product of Mitsubishi Rayon Co., Ltd. (registered trademark)}, and so forth can be used.

Furthermore, the measurement chip can be housed in a chemical reaction cartridge (JP-2006-337238A) that is proposed by the inventors of the present invention. The chemical reaction cartridge includes a configuration in which wells and a flow path are provided such that the contents of the cartridge are moved due to deformation thereof, caused by an external force, thereby causing a desired chemical processing to be executed. It is possible to house the measurement chip in the chemical reaction cartridge, and to cause hybridization to undergo in the chemical reaction cartridge

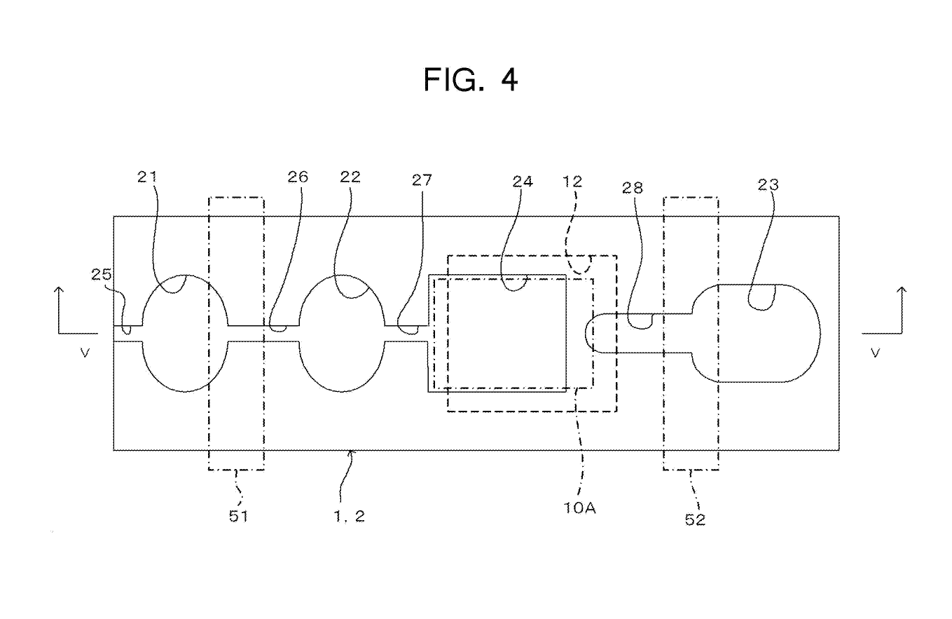

There is described hereinafter an example where the measurement chip is housed in the chemical reaction cartridge with reference to FIGS. 4 to 7. A target molecule detection chip 10A described later corresponds to the measurement chip, and the calibration chip, according to the present invention, respectively.

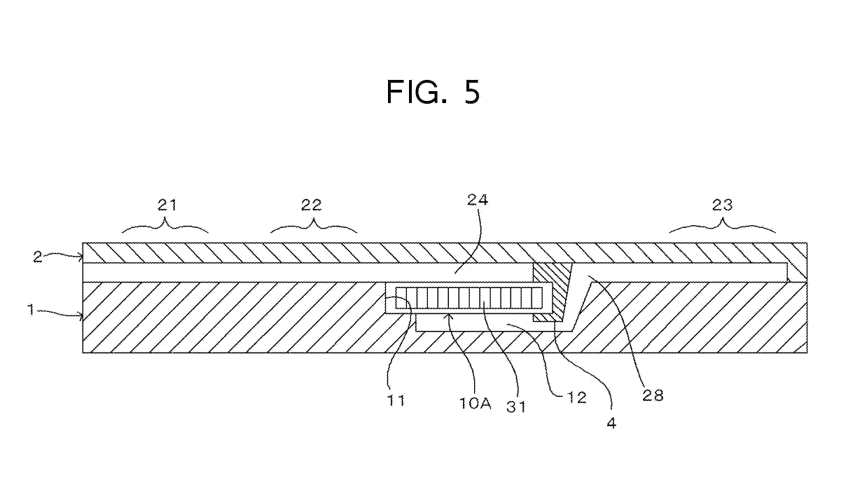

FIG. 4 is a plan view showing a configuration of the chemical reaction cartridge, and FIG. 5 is a sectional view taken on line V-V of FIG. 4.

As shown in FIGS. 4 and 5, the chemical reaction cartridge is provided with a substrate 1, and an elastic member 2 overlaid on the substrate 1.

Respective concaves in a predetermined shape, dented toward the surface (the upper surface in FIG. 5) of the elastic member 2 are formed in the rear surface (the underside in FIG. 5) of the elastic member 2. The respective concaves create empty spaces between the substrate 1 of the cartridge and the elastic member 2, thereby making up solution-holding chambers 21, 21, 23, a feeder 24 for supplying a solution, and so forth to the target molecule detection chip 10A, and flow paths 25, 26, 27, 28, as shown in FIGS. 4, and 5. Further, the flow path 25, the chamber 21, the flow path 26, the chamber 22, the flow path 27, and the feeder 24 communicate with each other in sequence, as shown in FIG. 4.

Because the substrate 1 of the chemical reaction cartridge, and the elastic member 2 are cemented to each other in regions other than the respective concaves, in the cartridge, the solution held in the respective concaves is hermetically sealed inside the cartridge, thereby preventing leakage thereof to outside.

As shown in FIGS. 4, and 5, a holding section 11 for holding the target molecule detection chip 10A, and a discharge section 12 provided on the rear side (the underside in FIG. 5) of the target molecule detection chip 10A, for holding a solution discharged from the target molecule detection chip 10A are formed in the substrate 1. Further, a holding member 4 for holding the target molecule detection chip 10A is fixedly attached to the rear surface of the elastic member 2. The target molecule detection chip 10A that is held by the holding section 11 is cemented to the substrate 1 of the chemical reaction cartridge, and the holding member 4 so as to be fixed inside the cartridge. Owing to such a construction as descried above, the target molecule detection chip 10A is fixed inside the cartridge, while preventing leakage of the solution from around the target molecule detection chip 10A, in the direction of the thickness thereof. Further, the discharge section 12 communicates with the flow path 28, as shown in FIG. 5.

The target molecule detection chip 10A is the through-type chip for detecting a target molecule by means of hybridization.

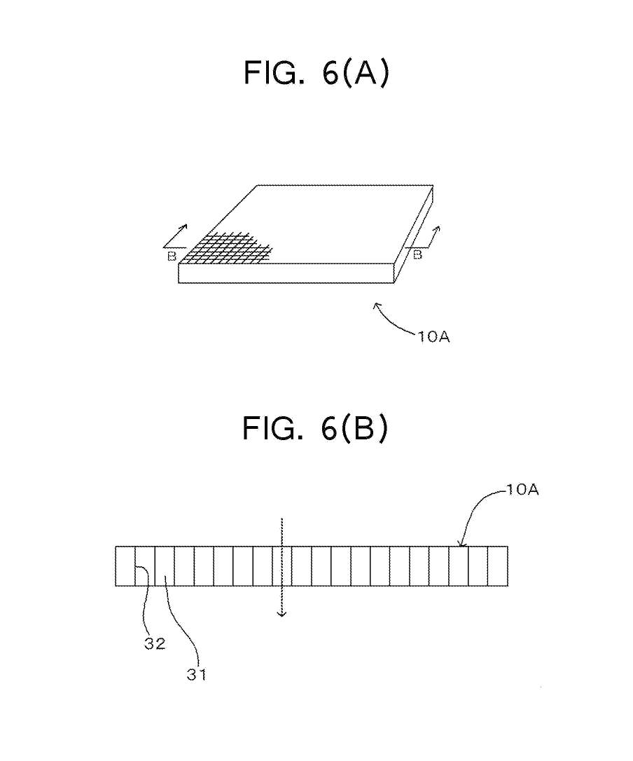

FIGS. 6(A) and 6(B) each are a view showing the construction of the target molecule detection chip 10A, in which FIG. 6(A) is a perspective view, and FIG. 6(B) is a sectional view taken on line B-B of FIG. 6(A). As shown in FIGS. 6(A) and 6(B), detection sites 31 with respective probes corresponding to individual target molecules, fixed thereto, are two-dimensionally disposed in the target molecule detection chip 10A, and the respective detection sites 31 are partitioned by a partition-wall 32. The respective detection sites 31 detect a target molecule in the solution penetrating through the target molecule detection chip 10A in the direction of the thickness thereof (in the vertical direction in FIG. 6 (b)) by means of hybridization.

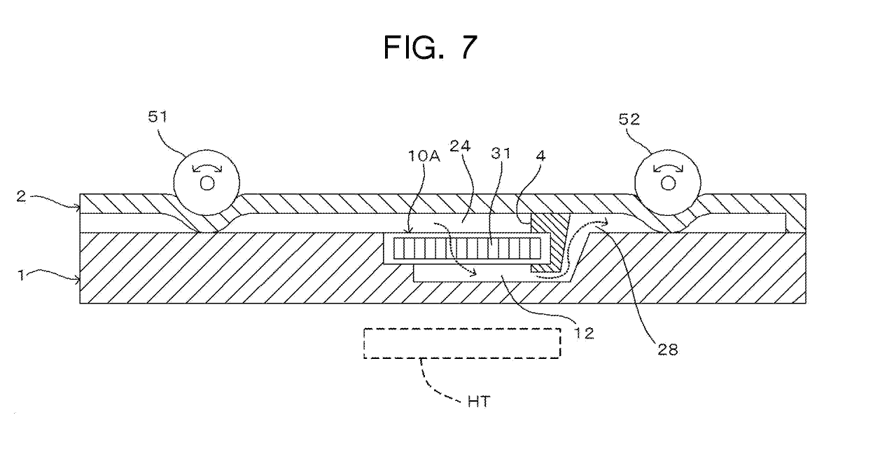

Next, there is described hereinafter an operation for solution transfer. FIG. 7 is a view showing an operation at the time of the solution transfer.

A solution as a test subject is pre-injected into the chamber 21 formed in the cartridge. The solution is injected by thrusting an injection needle into the chamber 21 via the flow path 25. The flow path 25 is provided with a stopper (not shown) made of an elastic material, kept in a sealed state, and the stopper is pierced through with the injection needle at the time of injection. By pulling the injection needle out of the stopper after the injection of the solution, a needle hole of the stopper is clogged up, whereupon the sealed state of the stopper is ensured.

Then, as shown in FIG. 7 and FIG. 4, the elastic member 2 is pressed down toward the substrate 1 by use of rollers 51, 52 that are provided at a predetermined interval, and the rollers 51, 52 are moved rightward. As a result, the solution injected into the chamber 21 is delivered to the feeder 24 via the flow path 26, the chamber 22, and the flow path 27. Further, the solution is caused to penetrate downward from the feeder 24 through the respective detection sites 31 of the target molecule detection chip 10A, thereby reaching the chamber 23 via the section 12, and the flow path 28.

Next, in FIG. 7, the rollers 51, 52 are caused to undergo a reciprocating horizontal movement a predetermined number of times while the rollers 51, 52 keep pressing down the elastic member 2. By so doing, the solution is caused to undergo a reciprocatory transfer between the chambers 21, 26, thereby causing the solution to pass through the respective detection sites 31 of the target molecule detection chip 10A a plurality of times. As a result, there is given a sufficient opportunity for the solution coming into contact with the detection site 31, the opportunity being deemed necessary for hybridization. Further, erroneous hybridization with a molecule other than the target molecule is reduced. The reciprocating horizontal movement by the rollers 51, 52 can be omitted if it is adequate as a condition for hybridization to do so.

As shown in FIG. 7, the temperature of the solution may be kept at a value suitable for hybridization with the use of a heater HT for the duration of the hybridization.

After execution of the operation for the hybridization, described as above, the target molecule subjected to the hybridization in the target molecule detection chip 10A is detected by use of a predetermined reading system, and so forth. The target molecule may be detected inside the cartridge without taking the target molecule detection chip 10A out of the cartridge, or the target molecule may be detected after the target molecule detection chip 10A is removed from the cartridge.

In this case, if the calibration chips (the target molecule detection chips 10A) are housed in the same chemical reaction cartridge, and hybridization is applied thereto in the cartridge at the time of calibration, this will enable respective hybridization conditions to be in agreement with each other. In the case where chips (a calibration chip, and a measurement chip) are housed in the chemical reaction cartridge, respective hybridization conditions for the chips can be brought in agreement with each other with high precision, thereby enabling measurement precision of the concentration to be enhanced. Further, even in the case where chips are housed in the chemical reaction cartridge, a target molecule may be detected with the use of the same reading system at the time of calibration, and at the time of measurement, respectively.

Thus, with the concentration measurement method according to the present invention, the concentration of a target molecule in the solution as the test subject is worked out on the basis of a measured quantity of light, found in the step of finding the measured quantity of light, by use of the relationship between the concentration of a target molecule in a calibration liquid, found with respect to a calibration chip, and a measured quantity of light, so that a quantitative measurement of the concentration can be made.

With the concentration measurement chip, the relationship between the concentration of a target molecule in the calibration liquid in a specific hybridization condition and the measured quantity of light is obtained as the calibration information on the concentration measurement chip, so that a quantitative measurement of the concentration can be made.

While the present invention has been shown and described with reference to certain exemplary embodiments thereof, other implementations are within the scope of the claims.

It will be understood by those skilled in the art that various changes in form and details may be made therein without departing from the spirit and scope of the invention as defined by the appended claims.

The invention can be widely used for a concentration measurement method for measuring the concentration of a target molecule by use of a measurement chip provided with a probe molecule fixed on a substrate, and so forth. Further, application of the invention is not limited to a DNA chip. The probe molecule as well as the target molecule of the chip according to the invention, includes not only nucleic acid but also protein, antibody, and so forth.

What is claimed:

1. A concentration measurement method for measuring the concentration of a target molecule by use of a measurement chip provided with a substrate and a probe molecule fixed on the substrate, said method comprising the steps of:
executing hybridization in a specific hybridization condition, by use of a calibration chip identical in performance to the measurement chip, thereby finding a relationship between concentration of a target molecule in a specific range of a calibration liquid with respect to the calibration chip and a measured quantity of light;
finding the measured quantity of light at a time when hybridization using the measurement chip is applied to a measurement target solution under the specific hybridization condition; and
working out concentration of a target molecule in a specific range of the measurement target solution, said specific range being identical to the specific range of the calibration liquid, on the basis of the measured quantity of light, found in the step of finding the measured quantity of light by use of the relationship found with respect to the calibration chip.

2. The concentration measurement method according to claim 1, wherein the hybridization condition includes temperature of the hybridization or a labeling method for a target molecule.

3. A concentration measurement chip comprising a substrate, and a probe molecule fixed on the substrate, said concentration measurement chip being capable of measuring concentration of a target molecule bonded to the probe molecule through hybridization, wherein a relationship between concentration of a target molecule in a specific range of a calibration liquid in a specific hybridization condition with respect to a calibration chip identical in performance to the measurement chip, and a measured quantity of light is obtained as calibration information on concentration of the target molecule in a specific range identical to the specific range of the calibration liquid and the quantity of light.

4. The concentration measurement chip according to claim 3, wherein the measured quantity of light at a time when the hybridization using the measurement chip is applied to the measurement target solution under the specific hybridization condition is found, and the concentration of the target molecule in the measurement target solution is worked out on the basis of the measured quantity of light, found in the step of finding the measured quantity of light by use of the relationship found with respect to the calibration chip.

5. The concentration measurement chip according to claim 3, wherein the hybridization condition includes temperature of the hybridization, or a labeling method for a target molecule.

6. A concentration measurement chip comprising a substrate, and a probe molecule fixed on the substrate, said concentration measurement chip being capable of measuring concentration of a target molecule bonded to the probe molecule, wherein a relationship between concentration of the target molecule in a specific range of a calibration liquid in a specific bonding condition with respect to a calibration chip identical in performance to the measurement chip, and a measured quantity of light is obtained as calibration information on concentration of the target molecule in a specific range identical to the specific range of the calibration liquid and the quantity of light.

7. The concentration measurement chip according to claim 6, wherein the condition where the probe molecule and the target molecule undergo bonding reaction includes temperature at a time when the probe molecule and the target undergo bonding reaction or a labeling method for the target molecule.

8. The concentration measurement chip according to claim 6, wherein the measured quantity of light is measured by use of an absolute-value light quantity system for a quantity of fluorescence (in the step of finding a measured quantity of light by use of the concentration measurement chip).

9. The application method for a measurement chip according to claim 6, wherein the bonding reaction between the probe molecule and the target molecule includes hybridization between proteins or antigen-antibody response between protein and antibody.

10. A probe coefficient calibration system and a probe concentration measurement system characterized in measuring the measured quantity of light in an absolute-value light quantity system for a quantity of fluorescence in the step of finding a measured quantity of light in the measurement method according to claim 1.
